(19) United States
(12) Patent Application Publication
(10) Pub. No.: US 2009/0094229 A1
(43) Pub. Date: Apr. 9, 2009

(54) METHOD AND APPARATUS FOR EXPLOITING 'TRACE' FUNCTION TO SUPPORT DATABASE INTEGRATION

(76) Inventors: Mark Warne Ferrel, Frederick, MD (US); Eric Kenneth Barnum, Germantown, MD (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/201,622

(22) Filed: Aug. 29, 2008

Related U.S. Application Data
(60) Provisional application No. 60/977,223, filed on Oct. 3, 2007.

(51) Int. Cl. G06F 7/06; G06F 17/30

(52) U.S. Cl. 707/5; 707/102; 707/E17.014; 707/E17.045

(57) ABSTRACT

A data processing method manipulates the internal command and communications controls of a database server to redirect certain data, for the purpose of developing a data integration cross reference for equivalent or ostensibly-equivalent fields. At least two databases can be cross referenced wherein the databases have fields that are similar or identical. Alternatively, an extension table can be developed to align a database to a standardized reference, such as a set of XML field labels. A ‘trace’ function of at least one monitored database server accumulates a log of database events and associated data field contents for memory access steps that involve creation or alteration of a field or field value, or that trigger an operation (e.g., create new, edit, delete, trigger event, etc.). The log of events from the monitored server is communicated or made accessible in real time to a middleware interface program, a remote server, or to another process, wherein correlation of the logged data from the monitored server versus reference values is used tentatively to assign field equivalence.

### CROSS REFERENCE TO RELATED APPLICATION

This application claims the priority of U.S. Provisional Application Ser. No. 60/977,223, filed Oct. 3, 2007.

### FIELD OF THE INVENTION

The invention relates to automating the process of logically equating the fields of different databases, specifically by exploiting the “trace” function that is provided to assist operators in debugging.

### RELATED ART

Many software applications have been written and used for various business and other applications that maintain stores of information tailored to the operations of their owners. These information stores often comprise lists of variable values organized under categories or fields. Identifying information is stored under certain headings or fields that are considered keys. Each entry of identifying information (which might concern a person, place, thing, transaction or the like) is related to variable values that are stored under any number of other headings or fields, indexed for association with the identifying field value. Various specific configurations and degrees of complexity are possible. But inasmuch as the owner only needs certain information and plans to use the information only in a certain ways to serve the owner's interests, the organization of the information store or database, is specific to the owner's applications and needs.

Databases contain multiple fields that are useful as keys. Fields may contain values related as unique or not unique, referenced one-to-one, or one-to-many, or many-to-many, versus other fields containing variable values. The fields have labels or other logical identifiers that organize what the values are intended to mean. The fields store items of information with importance for some specific purpose. Groups of fields may be useful together for certain purposes. The values of some fields may be derived from the values of other fields.

Examples might include a serial number key value, an identity or description of a person, place or thing, an associated date, an amount representing value or some other number, etc. A database schema determines the nature of field values such as whether they are letter strings or numbers, their formatting as to byte size, the valid range of values, which fields are unique and which are not, whether fields are related one-to-one, one-to-many or otherwise, the logical or mathematical relationships by which some field values are derived from others, etc. The developers of application programs that use the database know what the field values contain and their limitations. In an ideal world, such information would be reduced to documentation and updated through the evolution of revisions and extensions. In the practical world, errors can occur if one proceeds to use or modify data without a complete understanding of the implications.

In the same database, it is possible to maintain different keys to manage information of different types. Thus, for example, a manufacturer might have a database with fields keyed to its employees, other fields keyed to its customers and further fields keyed to its products, vendors and so forth. These different types of data can be related by common values in one or more fields. For example, a vendor may supply a part for a product that is assembled by an employee and sold to a customer, such that various parties are related by virtue of the product.

Often, a database that was organized for and populated with information relevant to one such business application contains stored information that would be useful to a different business application. It is not a trivial matter to make use of such information even if data access is available, unless one also understands and appreciates all the attributes, limitations and relationships that are embodied in the source database.

Among many possible scenarios, a business may have the need to upgrade its data processing systems and to import data from one software vendor's system into another. However the database fields of the two databases are unlikely exactly to align. Even if one has access to the data (the database schema including field labels, the field values and the relationships of the fields) porting data from a legacy database to a new application is risky.

There are opportunities for obtaining beneficial information if diverse databases can be related by noting the presence of fields and field values that correspond. In a simple example, different businesses who maintain name and address or telephone number and email address information may have an overlapping customer base wherein it could be helpful for an operator of one database to obtain information about its customers by using the customer name (or another field) as a reference value that happens to be carried in a different database in field that is related to variable values of a further field that is of interest.

Among different business entities, there are additional relationships that tend to dictate databases with the same or similar values stored in the databases of the different business entities. When the different business entities interact with one another to serve some larger common interest, there is degree of redundancy in the data stored in their databases, while at the same time, the respective databases are typically tailored for their owner's business. Underlying database structures of applications that participate in some shared purpose often replicate data, but have differences such as field value formatting, naming conventions, and associated environmental variables. The disparate applications that maintain data fields for a limited purpose useful their owners or enterprises evolve to contain some fields with similar data values, which are possibly not exactly identical or may be formatted differently, and may be subject to different requirements according to the needs of their home application.

Conventionally, assuming that data communications are available to access the different databases (e.g., to inquire with a remote database for all the field labels and variable values that are referenced to an identified customer name), one cannot dependably exploit the results as useful information without some knowledge of what the various fields are intended to represent and how they are related to the key value (in this case the customer name).

Various database integration technologies attempt to address these problems and to permit a given enterprise operating its own database to benefit from information that is obtained from some other database in fields that can be related from one database to the other. However, the cross-database relations are inferred manually.

The information from the given database and the other database needs to be related or cross referenced to preserve logical relationships between field values. For example, a retailer's database might be configured to manage product inventory and to handle sales transactions for products to be shipped to the addresses of retail customers. The retailer's database may communicate with suppliers' databases about restocking and with bank or credit card company using the customer's credit card or other account number. It is likely that the bank or credit card company has stored fields for the customer's address. However customers may have multiple addresses, e.g., plural locations or both a billing address and a shipping/receiving address. The values in the fields of different databases may be similar or even identical, but may have different reasons for existence.

Databases that have similar variable values stored in related fields is addressed by integrating the databases, which integration might be more or less extensive. Fairly standard methods and mechanisms are used to pass field labels and variable values between database entities. Ideally, no application or database entity is caused to apply a variable value obtained from another database, for a purpose that is inconsistent with the reason for the existence of that variable in its home or source database.

Among others, known techniques include passing predefined data streams with very specific contents that contain headers or identifiers that are standardized by industry or are pre-agreed between the communicating entities. Extended Markup Language (XML) standards provide identifiers that have associated variable definitions and specifications. So-called “middleware” programs can seek to match a source field in one database to a destination field in another, perhaps including reformatting data or generating destination variable values by performing operations on source variable values. These techniques make source data available from one enterprise useful to serve the mission of another enterprise. Data warehousing can be used, e.g., wherein multiple enterprises share a database that is larger than their own needs and has diverse variables that are commonly related to unique key values. Ontology methods can be applied to identify and exploit variables that are maintained for the same purpose or for different reasons by different entities.

These and other examples of integrated or interconnected databases are commonly referred to as “interface engines.” Each of these approaches rely on the consolidation of databases, typically tied to unique identifiers, which are passed via communication protocols such as middleware or open database connectivity (“ODBC”) source sharing. A data value communicated between interfaced database entities creates a programmed “event” in the consolidated system.

The character and rippling effects of communications between entities in the consolidated system can be complicated, requiring substantial knowledge of the source and destination databases or other application entities. Ontological mapping is helpful but does not resolve management problems. For example, unexpected results can arise from database customization. Version-driven changes made to the core data structure have effects whose implications may not be apparent until values are passed through the interface engines. The changes might only cause problems under certain intermittent conditions. Interface engines tend to create complicated maintenance issues associated with database configuration changes. Typical interface engines make limited if any use of meta data that might be helpful to backtrack when debugging such problems.

Modern enterprises migrate toward highly specialized applications for the value they bring in precisely and efficiently serving the specific data needs of a specific end user or application. For speed and efficiency, it is likely that the needs of a given enterprise will be most effectively addressed by a specific application customized for serving that information requirement, as opposed to a generalized application having various elements that are not used by that enterprise.

A problem arises because there may be multiple specialized applications each delivering slightly different variations of some piece of information. Resolving the differences conventionally requires that an end user have knowledge of each source of similar data to understand the idiosyncrasies of the source and the data it produces, as well as the vulnerabilities of the subsequent processes that will make use of the source data.

It would be advantageous to develop a system as well as analytic ability to create and assess a consolidated view of each system's information output by observing that system's operations. While modern integration technology might address this on a programmed single system by single system basis, what is needed is an approach that does not need customized programming attention. A system that is free of the need for customized analysis ideally could function over any level of specialization. By comparison, over time the increasing specialization of databases to serve specific needs will defy such integration technologies.

This issue is further compounded because database technology changes and advances in database technology tend to circumvent or render inadequate certain older integration approaches. The adoption and maintenance of “legacy” systems demonstrates how the value of specialized information outlives the actual technology of the database, software application, and integration of that system. The unchanging variable is information, which the invention allows to be made equivalent between legacy and new, across environments, and across barriers to system implementation and use.

In the prior art, data modeling is a way to integrate large database systems in a data warehouse environment. This method involves an extensive requirements analysis phase whereby individual tables within each database are manually analyzed using available documentation, assessed, and then key fields from each system are paired into extension tables (XTs). Each extension table acts as a “mediator” of sorts whereby selected primary and foreign keys are aligned, allowing data in the foreign database to be related to a key in the primary database, by first relating the primary key to the foreign data tables through the correspondence of the primary and foreign keys, as identified in the extension or index tables.

In the short term and with appropriate care to accurately align the primary and foreign keys, this integrates the primary and foreign system. Queries may be conducted against them as a combined unit, often in the form of a home-built query tool or through various query intelligence tools. However, like the legacy systems that such data warehouses comprise, the integrated database are logically clustered together into islands by virtue of the extension tables that tie them in pairs. As these and additional databases are integrated in pairs, limitations are encountered as to data storage capacity, processor performance, communications requirements and in general the need for increasing infrastructure and processing and communication capacity and tools.

It would be advantageous if serial chains of customized cross-querying communications (always between paired databases based on purportedly equivalent key fields) could be replaced or supplanted by a technique to automatically correlate fields in two or more databases, for example to generate effective extension tables automatically, to correlate database fields, or to control or at least assist in importing data fields from one database into another, after determining with an appropriate level of confidence, that the two database have two fields that are sufficiently related as to provide a useful common key field.

These techniques can resemble a file aggregation approach used by some database integrators to reformat plural application file types or databases. All of the plural types or databases are reformatted where necessary to conform the files and to store them in a network directory commonly accessible to all “integrated” applications for read/write access. Once done, the various users or application functions are permitted to access and update the files according to set schedules or according to assigned priorities. One application is permitted read/rewrite access at a time. Such aggregations entail inefficiencies. The aggregations are not real-time. They can sometimes lose data (either through misplacement or mal-formatting). Often the effort to modify and conform the file types to conform to various common denominators takes more time and effort than a new schema or data modeling integration.

Another prior art technique relies on ontologies to address “many-to-many” parent/child relationships of fields in a data structure. They work best when the scale of complexity and hierarchical structures magnify parent-child relationships that are otherwise un-addressable via conventional use of unique and foreign ID key assignments within an entity-relationship table. Ontological mapping can help in database integration. It would be advantageous, however, if an automated technique could be used to assist in the process. Once completed, complex integrations represented by automatic techniques could be defined by ontological mapping.

Ontologies can be useful to identify and prevent redundancy that otherwise may occur because data fields in two databases might be equated or mapped as fields at different levels of database hierarchy. There may be multiple possible data fields with some field values that appear to equate. It is possible, when analyzing databases for equivalent fields, to be very cautious, e.g., to require high correlation and a large population of corresponding field values before concluding that two fields correctly map to one another in point-to-point equality. It would be advantageous if ontology techniques could be used to create cascading pathways that resolve redundancy via the mapping. However, it is disadvantageous to rely wholly on techniques that require study and analysis.

Another category of database integration is the composition of customized middleware software to translate between different applications and thereby integrate their disparate data sources. Middleware is customized for the purpose of driving specific applications. The queries and the data produced in response are related to the two applications that need to transfer data. Even more specifically, the transfer of queries and data is specific to the operations with which the inquiring application happens to be involved. This data may be a small subset of the data in the source database.

Middleware processes (or inquiring applications that use a middleware process) might be programmed to store all the queries and responses in an organized log that in some instances could comprise two or more fields that represent variable values related according to information involved in the query, i.e., a database of a sort. This information might be communicated to other systems. However, middleware as such is not useful to assist in garnering or interpreting data apart from the simple contents of the query and response. What is needed is an organized way to learn data field identifiers and associated variable values over a range of database operations that involve reading and writing data, altering fields, etc., and to put the information to efficient use for the benefit of networked applications other then the process that queries a database for variable values.

### SUMMARY

It is an object of the invention to automate the process of logically equating the fields of different databases. This is done specifically by exploiting the “trace” functions that are provided to assist operators in debugging and monitoring and by expanding upon the intended functionality of the source database management logic. More particularly, the database “trace” functions are employed to identify Insert, Update and Delete instances in which database fields and field values of a monitored database are modified. A trace log file is accumulated during the regular course of business of the monitored business and is transmitted to an analyzing process. The tracking information is used to mirror the operations in subscriber databases. A second database can be built or fields of a second database can be populated with field values that are obtained from the monitored database and are related by a common basic key value, and are at least tentatively equated by information from the monitored database.

These and other objects are met by a method for extracting useful content from a target database by observation of operation of the target database according to the present disclosure. The target database contains data storage accessed by a programmed processor that may be a local processor or one or more remote processors in data communications with the data store. The data store contains associated data fields that are related to one another according to a database schema, and variable values for the data fields. According to an inventive aspect, a data store is provided in addition to the data storage accessed by the processor maintaining the database. The additional data store may be local or remote and like the database, is configured to contain data fields and variable values. The additional data store, however, is used to develop a tentative or mirror database arrangement wherein data obtained by observing operations at the target database will be accumulated and used to postulate and then to test for the accuracy of a translation or extension table process.

The mirror database is developed by comparing data from the target database to a reference, especially a second database wherein the data from the target database is compared against the reference to find common key fields. It is also possible to define a reference that is less than a complete second database but has a list of possibly unique values in at least one field or combination of fields. The reference has at least one of a population of reference variable values and an organization of reference data fields, wherein the reference correlates in part with the variable values and the data fields of the target database. As a simple example, the reference may have name and address fields that are unique at least up to the point of two persons with the same name living at the same address.

According to an inventive aspect, the data from the target database that is used as the input data is not a field chosen by studying the contents of a dump of all the data in the target database. Instead, a trace operation in the programmed processor accessing the target database is invoked. In one example, the trace operation is enabled by patching the debugging function provided in structured query language databases (“SQL_Trace”) into all operations undertaken on the target database involving changes of values in the fields. In particular, the SQL_Trace function is used when accessing the target base for one of Insert, Update and Delete operations affecting the target database, and generates an event detail containing at least one of data field identifications and values involved in the operations. The event details for successive operations are stored in a log of events while operating the target database for read and write operations via the programmed processor. The log can be developed during operations of the target database in the regular course of its business. Alternatively or additionally, the log can be developed during queries applied to the target database through the programmed processor, which queries are received from a second processor engaged in developing the mirror.

The log of the events reported by the trace operation is correlated to the reference. This may involve correlation by finding in the log of events information that correlates with the reference. The mirror that was established is populated, i.e., the variable data fields are filled with variable values in the mirror database, and/or corresponding data field relationships are noted, so as to at least partly match data fields and variable values in the mirror or obtained using the mirror as an exchange table, with the target basis according to the reference.

Over successive events that access the target database and are reported, the mirror database is loaded with content that effectively emulates or mirrors the target database.

### BRIEF DESCRIPTION OF THE DRAWINGS

The drawings depict several embodiments as examples of the subject matter of the invention, it being understood that the invention is not limited to the embodiments disclosed as examples and is capable of variation within the scope of the appended claims. In the drawings,

FIG. 1 is a workflow diagram showing a data structure for supporting the data transfer of E2 subscriber databases along with the correlating communication paths. In this example the mirroring or cross referencing of database fields can be accompanied by language translation. An Input Repository Database is any source provider database support system repository for handling data transfer in a queued sequence to minimize latency impact on the source database that will provide integrated data to subscribing destination databases. The Input Repository Database also enables the switchboard matching operations of E2 to occur away from live system activity. Likewise, the Output Repository Database serves the same function on the subscriber side.

FIG. 2 is a simple block diagram showing how an extension table (““XT”) placed between two databases can process a query in one direction and/or a response in the other direction such data referenced to a key in one database may be supplied by reference to the other database through the extension table.

FIG. 3 is a block diagram corresponding to FIG. 2 and showing how the addition of plural databases leads a complex array of extension tables where an extension table is disposed between each possible pair of databases.

FIG. 4 is a schematic illustration wherein several database systems with servers coupled to data stores are connected over a network through middleware interfaces with variable naming conventions.

FIG. 5 illustrates one of the database systems in FIG. 4, wherein a trace function is invoked to monitor internal and/or external queries to produce a log file when operations are encountered that potentially change database values, especially, create, append, edit and delete memory access events.

FIG. 6 is a data flow diagram showing the invention as applied, for example, to a health information database.

FIG. 7 is an exemplary program script that can be executed against database system objects to identify underlying data structures to dynamically build mirror repositories for use in integrated data transfer in conjunction with an SQL_Trace operation when selected due to the processor operations encountering one of the aforesaid memory access events.

FIG. 8 is a data flowchart showing the transmission of the log file to a processor associated with the reference, such as a reference database, to develop a mirror database, or at least an extension table, based on the information collected as described.

### DETAILED DESCRIPTION

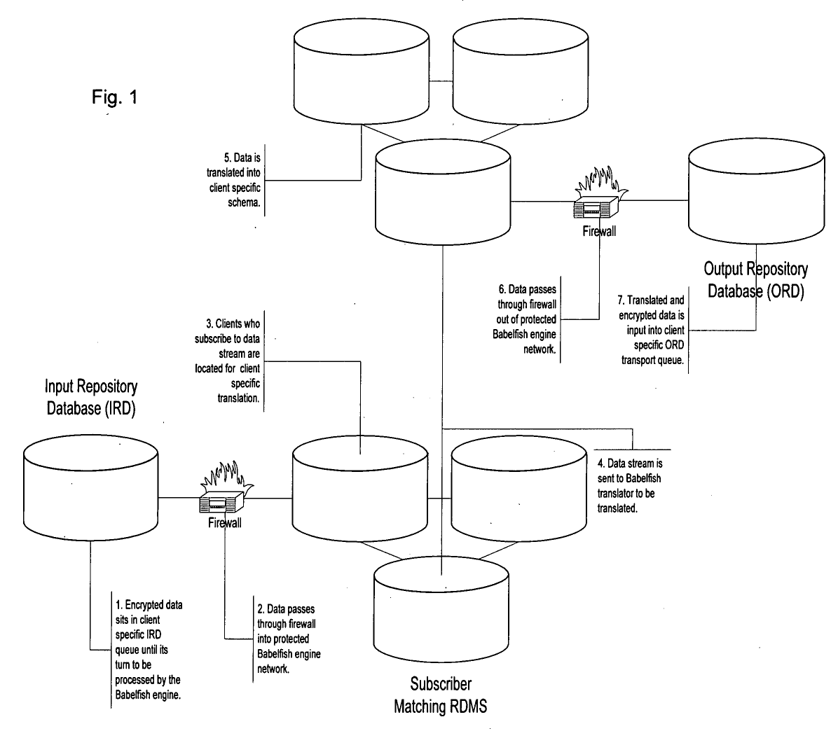

As shown in FIG. 1, it may be desirable to provide an automated technique for generating a version of an input repository database that is organized according to keys and field values that are arranged according to a subscriber matching system, and set up in an output repository database according to the specific requirements of the subscriber-client. The flow diagram in FIG. 1 also shows that this technique for arranging data in the output repository database can include language translation service as well as the correlation of fields that may have different labels and be formatted and related to one another according to schema in the output repository database that does not match the target source database and instead matches a different reference.

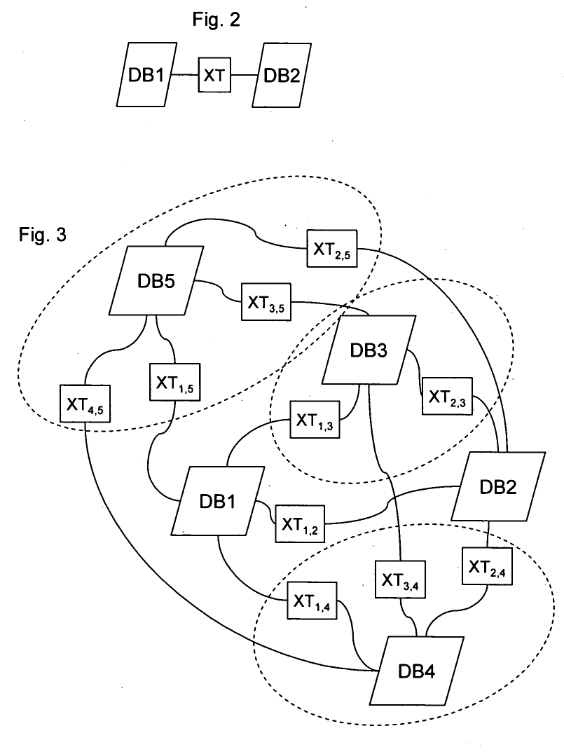

Generally, the idea is to generate one or both of a mirror database and an extension table, to relate the input repository to the output repository, but according to the schema according to the reference. In a situation of two databases only, an extension table XT (see FIG. 2) can provide an interface that operates as a linkage between databases DB1 and DB2, provided that the fields in the respective databases have been determined to represent the same information. This has the advantage that fields that are peculiar to one of the databases and are not found in the other, can be accessed by extension. The common fields are linked to the peculiar fields, enabling a query linked to the common field to produce the peculiar field value.

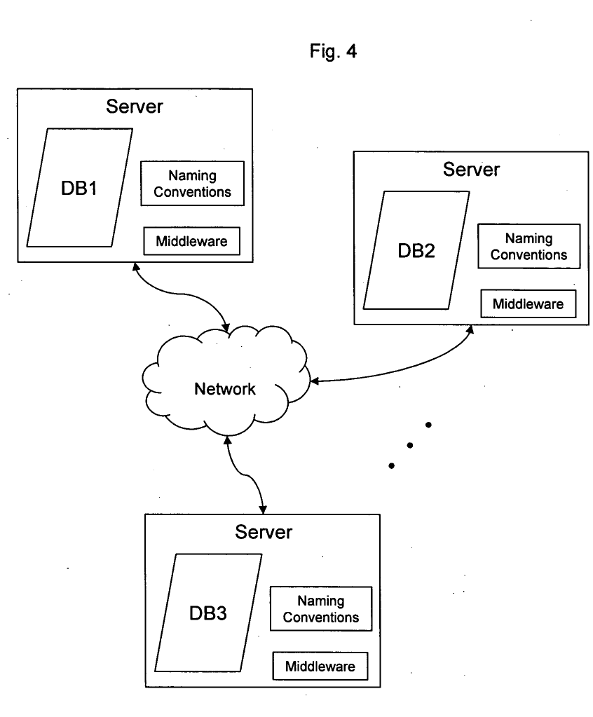

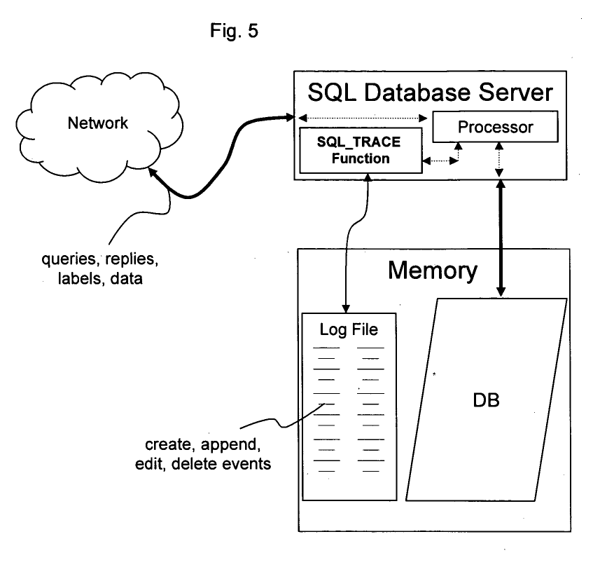

FIG. 3 shows, however, that this technique of interfacing by extension tables becomes more complicated as the number of databases increases. As more and more databases are added, the number of required XTs increases by the function of n(n−1)/2, where n is the number of databases. This complication is similar to what occurs in schema-based integrations, where the number of flows increases at the function of n(n−1).

Databases may vary widely depending on the reason that the database is operated (the application it serves). Nevertheless, if one examines extension tables that were produced by careful study and data modeling techniques that find and correlate the common field variables in each one, it will happen in many cases that a portion of the extension tables (XTs) are redundant. Particularly when there are alternative paths between a query and the responsive data store, the XTs along any of the alternative paths should ideally make the same connections and translations as the XTs along any other path between the same target data store (i.e., input data repository) and output.

However, redundant XTs are a source of fatal errors. The data warehouse defined by all the alternatively coupled XTs has multiple query paths for data retrieval and in practice, the connections and translations along alternative paths can differ. Even small differences are compounded when different paths traverse multiple different extension tables. In order to minimize the potential for errors, intense manual scrutiny is normally advisable when adding a new database to a warehouse of database coupled by extension tables (XTs). Ontology studies can be applied to impose a hierarchy of data relationships to reduce or eliminate query path redundancies that can lead to fatal errors. When a database or application is added, it is advisable to operate the old and new versions in tandem to determine if the addition has affected operation of the common linkages.

Database integration technologies can impose various new server processes and objects by which the integration is managed. Added processes introduce maintenance issues and tie up data server computational capacity, resulting in increased latency in the end user experience. According to an aspect of the present disclosure, changes are tracked through the innate database structure using a debugging trace tool such as the SQL_Trace object. Debugging trace tools are common to many database operating systems and structures. Use of the standard issue trace tool allows integration in the native data environment, without substantial burden to the native data functions of database access that have already been optimized to handle create/modify/delete instructions according to the programming of the associated processor. Integrating by inserting compact trace output instructions into already operational innate programmed controls of the database itself, is advantageous in that latency is greatly reduced, maintenance is simplified, and end users experience substantially the same operation of their applications and its access to the data store and provided without invoking the trace output.

In relying on the invention, a new server object does not need an investment by management to create and maintain sharing of data streams. The invention eliminates the need for all the different incoming and outgoing data streams that might be required in a conventionally integrated system. This radically simplifies data management because the necessary data emerging from the source data set is passed along with the variable value in each accessed fields during normal operations that through a parallel data path beginning with execution of the SQL_Trace function by the source data set's programmed processor.

No matter the integration method, the number of data communication protocols, or streams, that must be managed follows the n(n−1) formula, where n represents inbound/outbound communications amongst integrated data stores. The invention, like an ontology, simplifies this to n+1, where the +1 indicates the equivalency of data once made equivalent through the UDF integration within E2. However, unlike an ontology, the simplification occurs by point to point data element mapping rather than through the establishment of a new data structure with path cascades, as per prior art discussion about ontology.

According to an inventive aspect, the present data processing method manipulates the internal command and communications controls of a database server so as to cause the server to redirect certain data along a second path that parallels the regular operational data path, for the purpose of developing a data integration cross reference for equivalent or ostensibly-equivalent fields. As a result, integration can be accomplished during the course of regular operations.

At least two databases can be cross referenced wherein the respective databases have fields that are similar or identical. Alternatively, an extension table can be developed to align a database to a standardized reference, such as a set of XML field labels. The debugging ‘trace’ function of at least one monitored database server generates a record during the execution of memory access instructions. The sequential records produce a log and the accumulating log of database events and associated data field contents produce the information needed to correlate against an outside reference, especially a second database to which the targeted source is to be correlated. Each memory access steps that involves creation or alteration of a field or field value can produce a trace-debug instruction. Each database management step that triggers a memory access operation or a change in memory organization (e.g., Insert, Update, Delete) can trigger the log report event.

The log of events from the monitored server is communicated or made accessible in real time to a middleware interface program, a remote server, or to another process, wherein correlation of the logged data from the monitored server versus reference values is used tentatively to assign field equivalence.

The reference values can be the contents of another database to which the monitored database is to be cross referenced. The correlation can be determined from all or part of one or more field values, from similar field labels, including routinely encountered letter string synonyms, formatting details, associated metadata, and the like. By redirection of database command and communication controls over successive occurrences and in different situations, originally tentative assigned field equivalences can be fine tuned and proven. It is possible in this way to progressively more accurately develop equivalences by which a secondary data collection or database can be accumulated and populated with field values in a way that mimics access to the monitored database. Although only tentatively equivalent, the field values that are accumulated can be processed in many of the same ways as data obtained through authenticated access to the monitored database or via an authenticated extension table, but with much less complication and in a much shorter time.

This redirection of database events and associated values can be passed across any network via standard middleware, via periodic reporting of the log, via real tie messaging associated with occurrences in real time, or similar communication techniques. In one embodiment, a trace log is accumulated by monitoring a database over a period of time sufficient to access an exemplary population of fields and variable values. Off-line processing can comprise searching for equal field values, and upon determining a statistically significant degree of correspondence, to conclude that the associated variables represent the same data types. That is, the data are analyzed to assess and to document equivalences with a second database.

The technique provides and formalizes a standard toolset (apparatus and methods) for conforming database fields to make them equivalent, for providing supplemental fields and field values from a monitored database for cross referencing with a database that may have corresponding values maintained with different arbitrary labels, or may lack corresponding fields, or may have fields that are available but are not yet populated with values. In these situations, values can be inferred or assumed, and with successive recurrences can be known and interpreted with increasing confidence and certainty.

By acting as a single point of integration, the invention can be configured to integrate 100% with each data source. This source can be anything, even other integration schemas discussed above. As the data is “filtered” and matched to universal fields by the invention, appropriate integration data is passed back to the target system. In this case, “appropriate” means “client data” because it is possible that multiple clients may share a universal source via middleware and other technologies.

Because integration is at the data level, unrecognized data can be ignored in the target database whereas correlated data is made available to remote applications. After processing to a total correlation of variables insofar as the data could be recognized, subsequent changes can yet be made to the system via an appending process whereby new and removed data sources are recognized at the filter level.

According to an advantageous embodiment, the invention can be applied to aggregate plural databases using a master index. The master index can initially be defined as any exemplary database. Over time and successive integration of other databases using the techniques of the invention, the master index forms an increasingly useful and wide ranging common reference. Accordingly, instead of using one of two independent databases as the reference for integrating with the other of the databases, plural databases are integrated using the master index as the common reference. Each next database to be integrated is provided with a routine to invoke the trace log output process.

Preferably, the master index is embodied as a network server with a programmed processor accessing a database in response to communications over a common network, such as the Internet, to which numerous database servers are coupled. Each database server contributes to the common integration and benefits from the integration of other databases, preferably in a subscription arrangement. In this way, more and more database systems can be integrated into a master index of commercial data sources as more and more databases subscribe and are correlated with other databases.

The master index advantageously can be coupled with a language filtering mechanism, configured as the translator RDMS shown in FIG. 1, which renders the system substantially free of language barriers. Also provided is an index control management system (“ICMS”). The ICMS can function similar to a library's Dewey Decimal system and comprises administrative tools to “check in,” “check out,” create and delete universal data fields (UDFs) provided in the master index. The UDFs are used as the single points for integration of each and every data field in an integrated system. One and only one UDF exists for common fields.

The inventive method as disclosed can be applied to various different network environments. In Table I below, a sample code sequence is provided to illustrate an exemplary array build from the system objects in a source target database to populate the Object Monitor process used to create a defined XML stream, optionally translated, returned to the selected data source(s) as an information stream by which the system at the data source is related to the master index.

TABLE I
Exemplary Object Monitor Script

```
Set objObject = Server.CreateObject(“sysTables.ObjectName”)
  Set objXML = Server.CreateObject(“MSXML.DomDocument”)
  rsXML = objObject.SAdminObjectName(0)
  If objXML.loadXML(rsXML) Then
  Set objNodeList = objXML.documentElement.selectNodes(“row”)
    For Each objNode In objNodeList
    IsxObjectName = “”
    For Each objAttr In objNode.Attributes
    Select Case objAttr.name
    Case “ObjectName”:
    IsxObjectName = objAttr.value
    End Select
    Next
    Next
  Set objNodeList = Nothing
  End If
  Set objObject = Nothing
  Set objXML = Nothing
```

The inventive technique does not rely on any particular knowledge of the targeted source database. Provided that the debugging trace function generates a log of memory access/change events, the necessary data for integrating the database is collected into dynamic arrays regardless of how the data might be managed at the source database. Thus, the variable values of virtually any database can be captured by passively logging and monitoring events as described. The monitored output data is routed in raw or translated form to any other data set in online real time or offline batch communication so as to obtain data access to the logged event data.

According to an inventive aspect, the integration does not require substantial alteration in the nature or operation of the source database. The primary changes are insertion of the debugging trace instruction into the sequence of instructions associated with field and variable value changes, and providing a step to communicate the resulting sequential event reports, or preferably an accumulated log of event reports (e.g., daily or weekly, etc.) to the processor that is charged to correlate the data values with the reference, such as a master index or a second database. In this way, reliance is placed on the source (targeted) database to capture and route insert/update/delete events and move them to another system where they can be replicated for data values with similar meaning from an analytic or informatics perspective. But the operations of the source/targeted database need not be burdened and it is unnecessary for a human operator to study the arrangement of data fields and variable values to manually attempt to correlate fields in the source with fields in a reference that have the same meanings or at least can be used in similar ways or used to relate to further fields and variable values.

According to one example, steps to create a functioning integration system as described can include placing an XML wrapper on all source/target data sources. This wrapper can define the data source in XML (e.g., assigning labels and thereafter keeping the labels unique). The labels can be adopted by or chosen in view of labels that match a reference, preferably a master index. Next, a messaging component is inserted, such as a middleware/messaging component (e.g., HTML tunneling), to transmit the data to the system that will conduct analysis. Queries are handled at the engine level, with information culled from the target data sources.

The messaging component transmits event data (or an accumulated log or event data) through optional language filtering to the integration analyzing process, to report events when fields and/or variable values are changed. The analyzer filters and sends back information (if a query) or further transmits that data to one or more client systems identified by the filter. The client systems receive the information and can incorporate the transmitted information into the client's data source (filling out fields and variable value information reported from the source/targeted database to the analyzer and the client). Alternatively, the analyzer and/or the client system can compose extension tables and similar cross referencing information such that a query can be submitted later to the processor associated with the source/target database, seeking a report of data that is related to data in the client system but remains stored only at the source/target database.

The invention has a number of advantages. Among others, operational latency at the source/target database is only minimally affected. At the same time, building and filling out an effective index commences immediately and proceeds as the source/target database is used for data field and variable value changes, being driven by current database operations. It is not necessary for a human to study and consider fields and variable values in lists or reports. Integration through a “filter” allows for dynamic re-routing and on-the-fly integration. Though client systems may be separated, the principle of universality will apply to all systems. It is conceivable in certain fact scenarios, such as a merger of two companies and their databases, that by appropriately routing event log information, an integration could be effected in seconds.

The disclosed technique is adaptable because unidirectional reporting of events as a technique for supplying integration information is independent of the particular type of platform, logic and source. Preferably the technique is also prompt and efficient. Using dynamic reporting (or frequent batch reporting), over a wide area communication network such as the Internet, and exploiting techniques such as XML to inherently assist in standardization, a relatively seamless integration can be effected in a fraction of the time that might be needed to study, hypothesize, prove and apply an integration of two databases. After establishing an integration, subsequent modifications at the target system are processed dynamically.

No changes are needed to the actual data structure at the source/target database. Prior art modifies the data structure to create accommodations for differences between databases. Many times, these integrations are intended to replicate functionality specific to the application, not the database. However, the application-specific functions are accommodated into the data structure. Because the data structure is more complex, these introductions create extra-maintenance burdens avoided by the invention.

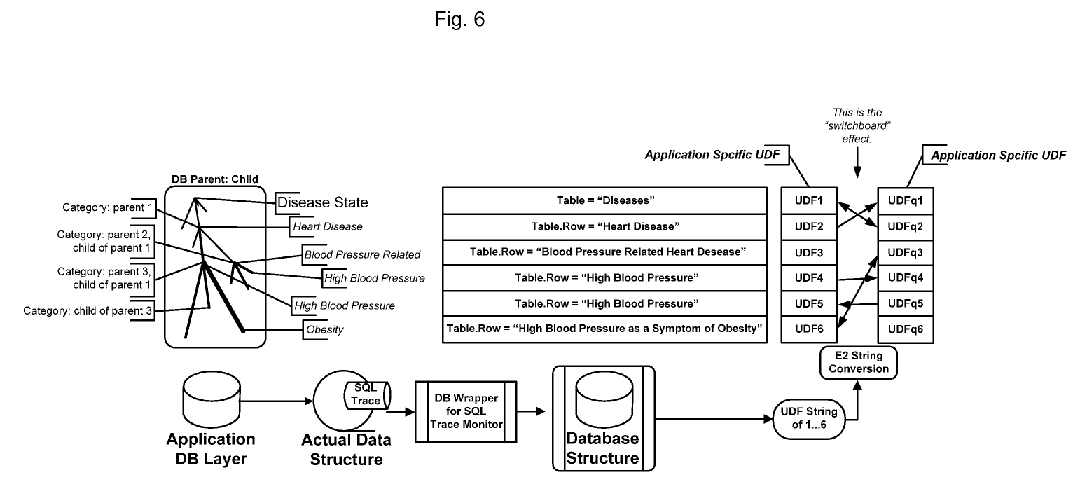

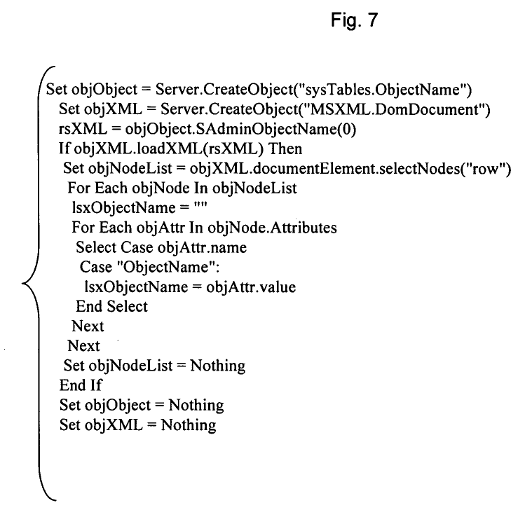

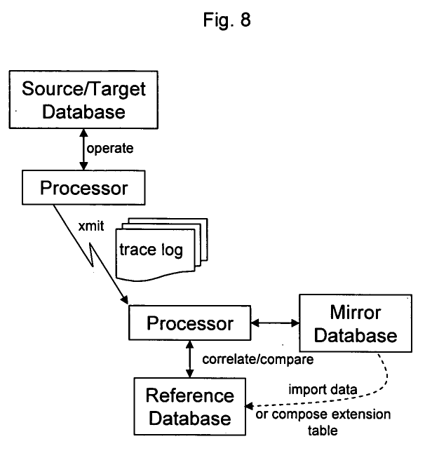

FIG. 6 shows how a data structure's tree diagram can branch down to a level of actual data values. In this example the data values represent disease states. The values are incorporated into an integrated system where there may be fundamentally different disease states in use.

As shown in the diagram, each value in the Application DB Layer is mapped as a universal data field (UDF) regardless of where it occurs in the data structure. SQL_Trace and other database administrative components trigger a change to the actual data structure that will be in the form of: Add/Edit/Delete data values. These are event triggers.

The invention passes these through the DB Wrapper to the invention's indexing system wherein each data value is mapped to a UDF. This is the code shown in Figure: Invention Code Sample. These UDFs are specific to the host databases and the applications residing on them, shown as UDF1, 2, 3, 4, 5, 6 . . . . A database for integration is also shown as UDFq1, q2, q3, q4, q5, q6 . . . .

Because applications and databases have different features, specializations, and end user groups, not every field needs to be integrated, and some cases, one system may become a data provider to the other. This results in an E2 String Conversion, where data values pass between the different databases, as defined by the invention's rule set.

The rule set is the logic defining the string conversion. It might say, for example, that:

| | | |
|---|---|---|
| UDF1 | is equivalent to | UDFq2 |
| UDF2 | populates | UDFq1 |
| UDF4 | populates | UDFq4 |
| UDF5 | is populated by | UDFq5 |
| UDF6 | is equivalent to | UDFq3 |

This string passed between all of the databases in the integrated system, goes to the database administrative components via the DB Wrapper, and the new values are replicated via the original event triggers.

It is an aspect of the invention to exploit database administrative components available to a first database system, especially debug tracing capability, to monitor and recreate database events at the data element level in another database system. This enables the two systems to be integrated and can be done without unduly burdening the source/target database except with respect to an inserted patch or subroutine that reads out the nature of data change operations when they occur. The result is to provide a way to regard the data elements of two systems as equivalent, with the further benefit of enabling other data elements in the two systems to be related by their common association with those elements that have been determined to be equivalent.

Equivalence data integrations are characterized by less latency and entail little human attention or maintenance, compared to traditional integrations. Data integrations that enable fields to be regarded as equivalent simplify administration of the resulting integrated system. Where “n” is a variable representing a number of database communication protocols, the complexity of the equivalence-integrated systems grows at “n+1,” whereas a traditional integration with paired extensions tables or the like grows at a rate of “n(n−1)” as the number of integrated systems is increased. Because data elements are being made equivalent to other databases containing similar data elements, applications relying on the data structure do not require modification as part of the integration work and ongoing maintenance.

The invention has been disclosed with respect to a range of examples and preferred embodiments. The invention is not limited to the embodiments disclosed as examples. Reference should be made to the appended claims rather than the foregoing description of examples, in order to assess the scope of the invention in which exclusive rights are claimed.

What is claimed is:

1. A method for extracting useful and relevant equivalent content from a target database by observation of operation of the target database, the target database having data storage accessed by at least one programmed processor, the data storage containing associated data fields that are related to one another according to a database schema, and variable values for the data fields, the method comprising the steps of:
providing a data store in addition to the data storage accessed by said processor, the data store being configured to contain a mirror database with data fields and variable values;
defining a reference having at least one of a population of reference variable values and an organization of reference data fields, wherein the reference correlates in part with the variable values and the data fields of the target database;
invoking a trace operation in the programmed processor when accessing the target base for one of insertion, updating and deletion operations affecting the target database, said trace operation generating an event detail containing at least one of data field identifications and values involved in the operations;
operating the target database for read and write operations via the programmed processor, thereby providing a list of successive said event details in a log of events;
analyzing the log of the events for correlation with the reference, and establishing and populating the data fields and variable values of the mirror database so as to at least partly match the data fields and variable values of the target basis according to the reference;
whereby over successive events, the mirror database is loaded with the content of the target database.

2. The method of claim 1, wherein the reference compares a second database and said analyzing comprises identifying at least one universal data field having variable values that are substantially paralleled in the target database and the second database, and wherein the at least one universal data field is employed as a key field in the mirror database.

3. The method of claim 1, wherein the data store for the mirror database comprises a memory accessible to the processor and wherein the processor is programmed to produce in the mirror database a version of the target database that is reconfigured according to the reference.

4. The method of claim 1, further comprising transmitting the log of events to at least one second processor, wherein the second processor is programmed for said analyzing of the log of events for correlation with the reference.

5. The method of claim 4, wherein the reference is derived from data fields and variable values in a further database accessed by the second processor.

6. The method of claim 5, further comprising configuring the mirror database as a tentative copy of the target database according to a schema of the further database.

7. The method of claim 6, further comprising merging the mirror database with the further database, thereby incorporating the useful content of the target database into the further database.

8. The method of claim 7, wherein said merging is accomplished after a monitoring phase during which the tentative copy is evaluated.

9. The method of claim 4, comprising transmitting the log of events to a plurality of processors, each of the plurality of processors analyzing the log of events for correlation with a local reference, and each of the plurality of processors providing a mirror database according to a respective said local reference.

10. The method of claim 1, further comprising monitoring the mirror database for correspondence with a local database, and upon achieving a predetermined degree of said correspondence, generating a cross reference by which the target database is inferred to correlate to the local database.

11. The method of claim 1, wherein said operating of the target database for read and write operations via the programmed processor comprises operation of the target database in a regular course of business associated with the target database.

12. A method for conforming at least two databases, comprising:
operating at least a first one of the databases to accomplish operations wherein at least one of variable values and field definitions in said first one of the databases is varied by operations comprising one of creation, alteration and deletion;
imposing a trace function on said at least first one of the databases, the trace function producing an output comprising an indication of the nature and content of said operations, and over successive said operations, accumulating a trace file successive said outputs;
analyzing the trace file by comparing the content of said operations to stored contents of at least a second one of the databases, and concluding at least tentatively from results of said comparing an extent to which at least one of variable values and field definitions of said second one of the databases are found to correspond to the variable values and field definitions of the first one of the databases; and,
generating an extension table for at least one of the first and second databases by which the variable values and field definitions of one of said databases corresponds to the variable values and field definitions of the other one of said databases.

13. The method of claim 12, further comprising identifying at least one universal data field having variable values that are substantially paralleled in the first and second databases, and wherein the at least one universal data field is employed as a key field for cross referencing related data fields in the first and second databases, respectively.

14. The method of claim 12, further comprising requesting and reading out from a source database and transmitting to a requesting database at least one variable value, wherein the source and requesting databases are each one of the first and second databases, and said variable value is an extension value referenced to a variable value and field definition at the source database.

15. The method of claim 14, wherein the variable value from the source database is a value beyond any variable value obtained in the output of the trace function.

16. The method of claim 12, wherein the output of the trace function comprises extended markup language containing an indexed array of component values providing for the dynamic access of mirroring database systems to map data streams for transport across the E2 network.

17. The method of claim 12, further comprising appending at least one of the first and second databases with data comprising at least one of additional variable values in existing fields and additional fields for containing variable values, wherein the data appended is obtained from the other of the first and second databases and is related according to correspondence obtained from said analyzing of the trace file.

18. The method of claim 12, wherein at least the first one of the databases is a structured query language (SQL) database.

19. The method of claim 12, wherein said analyzing of predefined equivalent values comprises searching for at least one field in the first and at least one field in the second databases for variable values that correspond at least substantially, and tentatively concluding that said respective fields in the first and second databases correspond.

20. The method of claim 19, further comprising relating at least one additional field in one of the first and second databases to at least one field in the other of the first and second databases, based on said tentative conclusion that said respective fields correspond.
